(19) United States
(12) Patent Application Publication
(10) Pub. No.: US 2008/0068727 A1
(43) Pub. Date: Mar. 20, 2008

(54) OPTICAL ZOOM MECHANISM

(76) Inventors: Gary Peter WIDDOWSON, Hong Kong (HK); Siu Yan Neal HO, Hong Kong (HK)

Correspondence Address: OSTROLENK FABER GERB & SOFFEN, 1180 AVENUE OF THE AMERICAS, NEW YORK, NY, 100368403, US

(21) Appl. No.: 11/532,813

(22) Filed: Sep. 18, 2006

(51) Int. Cl. G02B 15/14

(52) U.S. Cl. 359/694

(57) ABSTRACT

An optical zoom mechanism is provided that comprises a first zoom lens movable along a linear axis and a second zoom lens movable along the same linear axis as the first zoom lens, both zoom lenses being connected to a support structure. First and second direct drive linear motors are coupled to the first and second zoom lenses respectively, and they are operative to independently move the zoom lenses along the linear axis. First and second encoders coupled to the first and second direct drive linear motors respectively are operative to independently measure the positions of the first and second zoom lenses.

### FIELD OF THE INVENTION

The invention relates to an optical zoom system, and more particularly, to an optical zoom system comprising two or more zoom lenses or groups of lenses.

### BACKGROUND AND PRIOR ART

Optical zoom systems are used in a wide variety of applications, from consumer electronic products, such as digital cameras and mobile telephones, to industrial automation applications. In semiconductor assembly and packaging, optical zoom systems are used in applications such as die bonding and flip chip bonding, where it may be necessary to view an object such as a leadframe at one magnification level, and another object such as a die at a different magnification level.

An example of an optical zoom system that is currently employed in the art is described in U.S. Pat. No. 6,549,341 entitled “Mechanism for Rotating a Cam Barrel of a Zoom Lens”. The optical zoom system employed here uses a rotary motion system and a cam mechanism to actuate a plurality of lenses with respect to one other. A disadvantage of such a system is that the actuation mechanisms used are not capable of simultaneously achieving high-speed motion and high accuracy. With this device, if high speed is required, it is necessary to sacrifice accuracy. Alternatively, one can design such a device to achieve high accuracy but the zoom system can only operate at a very low speed, such that it renders itself ineffective for applications where the system needs to change the magnification level very rapidly. In semiconductor packaging, high magnification changes would be required, for instance, between consecutive semiconductor die bond operations.

It would be desirable to design an optical zoom system that can operate at high speeds and is also able to attain high motion accuracy.

### SUMMARY OF THE INVENTION

It is thus an object of the invention to seek to provide an optical zoom mechanism that reduces some of the aforesaid shortcomings of prior art optical zoom systems by being capable of simultaneously achieving high process speed and high accuracy.

Accordingly, the invention provides an optical zoom mechanism comprising: a first zoom lens movable along a linear axis that is connected to a support structure; a second zoom lens movable along the same linear axis as the first zoom lens that is connected to the support structure; first and second direct drive linear motors coupled to the first and second zoom lenses respectively that are operative to independently move the zoom lenses along the linear axis; and first and second encoders coupled to the first and second direct drive linear motors respectively that are operative to independently measure the positions of the first and second zoom lenses respectively.

It would be convenient hereinafter to describe the invention in greater detail by reference to the accompanying drawings which illustrates a preferred embodiment of the invention. The particularity of the drawings and the related description is not to be understood as superseding the generality of the broad identification of the invention as defined by the claims.

### BRIEF DESCRIPTION OF THE DRAWINGS

An example of a preferred embodiment of an optical zoom system in accordance with the invention will now be described with reference to the accompanying drawings, in which:

FIG. 1 is an isometric view of an optical zoom system according to the preferred embodiment of the invention;

FIG. 2 is an isometric view of the optical zoom system that illustrates the relative positioning of the linear guides, linear motors, encoders and base support structure of the optical zoom system;

FIG. 3 is an isometric view of the optical zoom system that illustrates the position of a main optical bracket and zoom lens of a top half of the optical zoom system;

FIG. 4 is an isometric view of the optical zoom system that illustrates the position of the main optical bracket and lens of a bottom half of the optical zoom system;

FIG. 5 is an isometric view of the optical zoom system that illustrates an optical focusing portion of the system; and

FIG. 6 is an isometric view of the guide rails showing a region where the motions of the optical zoom system's zoom lenses may overlap.

### DETAILED DESCRIPTION OF THE PREFERRED EMBODIMENT OF THE INVENTION

FIG. 1 is an isometric view of an optical zoom system 10 according to the preferred embodiment of the invention. The optical zoom system 10 includes a support structure, such as base support 12 which includes at least one vertical sidewall. The base support 12 supports a structure including first and second encoders 28a, 28b, a linear guide 34 for guiding motion of a focusing lens 32, and a focusing lens actuator 36 comprising a direct drive linear motor for driving the focusing lens. The structure also includes a focusing lens optical encoder 38 for determining a position of the focusing lens 32.

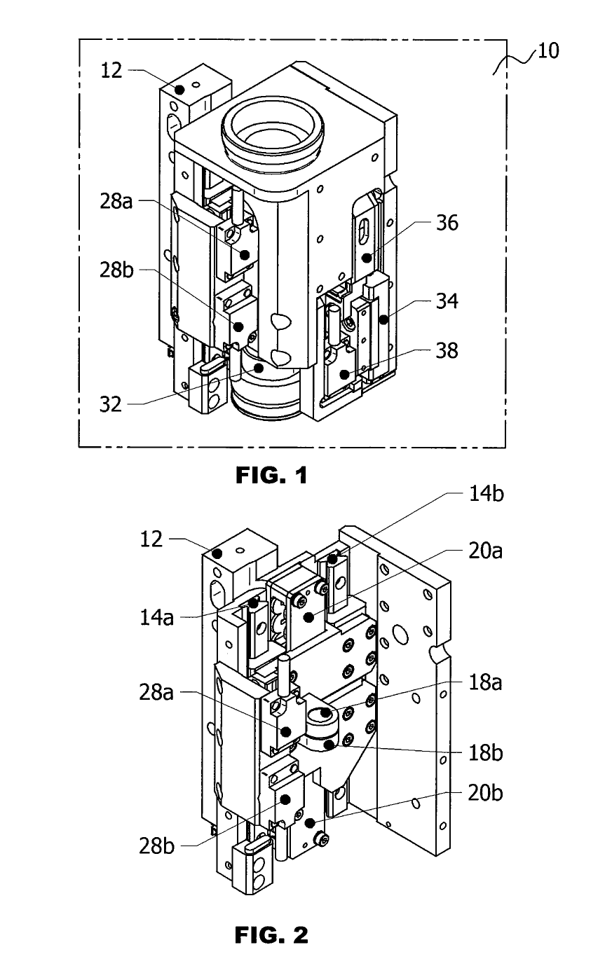

FIG. 2 is an isometric view of the optical zoom system 10 with part of its housing removed for illustrating the relative positioning of the linear guides 14a, 14b, linear motors 20a, 20b, encoders 28a, 28b associated with first and second optical zoom lenses 18a, 18b, as well as the base support 12 of the optical zoom system 10. The zoom lenses 18a, 18b are connected to the base support 12 and are movable in the same linear axis. The two linear guides 14a, 14b guide the movement of the optical zoom lenses 18a, 18b along the single axis, that is up and down according to the illustrated embodiment. A pair of linear motors 20a, 20b, each coupled to one optical zoom lens 18a, 18b and encoders 28a, 28b respectively, are operative to independently move the zoom lenses 18a, 18b along the linear axis, and the encoders 28a, 28b independently measure the respective positions of the zoom lenses 18a, 18b.

The highly rigid linear guides 14a, 14b are precisely assembled to the base structure 12, such that unwanted motions in directions perpendicular to the desired motion direction and rotations around the desired motion direction are minimized during operation.

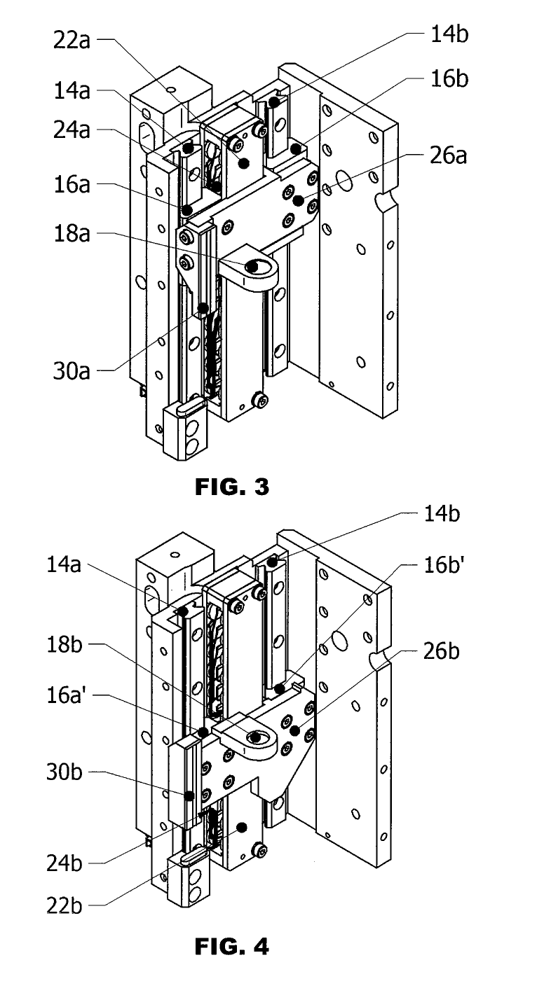

FIG. 3 is an isometric view of the optical zoom system that illustrates the position of a main optical bracket 26a and zoom lens 18a of a top half of the optical zoom system 10. On the top half of the movable zoom system, each linear guide 14a, 14b is spaced parallel to each other and further comprises separate linear guide blocks 16a, 16b, which form a part of the motion system for the top zoom lens 18a.

FIG. 4 is an isometric view of the optical zoom system that illustrates the position of a main optical bracket 26b and zoom lens 18b of a bottom half of the optical zoom system 10. On the bottom half of the movable zoom system, each linear guide 14a, 14b further comprises separate linear guide blocks 16a′, 16b′, which form a part of the motion system for the bottom zoom lens 18b. It should be noted that it is also possible for more than two guide blocks to be used in a single lens motion system for additional stability. Moreover, each linear guide 14a, 14b may comprise a single guide rail for guiding the top and bottom zoom lenses 18a, 18b but separate guide blocks are connected to each zoom lens for guiding each zoom lens.

Instead of linear guides, the optical zoom mechanism may also utilize air bearings or flexure bearings for guiding either or both of the zoom lenses 18a, 18b along the linear axis.

The linear motors 20a, 20b comprise relatively stationary coil assemblies 22a, 22b cooperating with magnet assemblies 24a, 24b that are movable relative to the coil assemblies and which are connected to the respective zoom lenses 18a, 18b via connecting brackets 26a, 26b. In another embodiment, the linear motors 20a, 20b may be manufactured in one structure. Alternatively, the linear motors may each comprise relatively stationary magnet assemblies and movable coil assemblies that are movable with respect to the magnet assemblies. The magnet material is preferably made from NdFeB material and the connecting brackets from a lightweight material such as aluminum, aluminum alloy, magnesium or fiber reinforced plastics, so as to minimize power dissipation during the operation of the system.

Instead of the optical encoders described above, other encoders such as magnetic-type encoders and capacitive-type encoders may be used to measure the positions of the zoom lenses 18a, 18b.

Two optical encoder readheads 28a, 28b are placed at fixed positions such that during the movement of the each lens 18a, 18b, an electrical signal is generated by their cooperation with an optical scale 30a, 30b. Upon conditioning of these signals, the position of each lens 18a, 18b is known with respect to one another and can be controlled independently. In an alternative preferred embodiment, in which the encoder readheads 28a, 28b are moving, and the scales 30a, 30b are stationary, the two scales 30a, 30b may be incorporated into a single scale.

It is also necessary to have a focusing lens 32 in order to implement a complete optical zoom system. Due to the possible range of motions of the zoom lenses 18a, 18b, it may be necessary for the focusing lens 32 to be movable in the same direction as the zoom lenses.

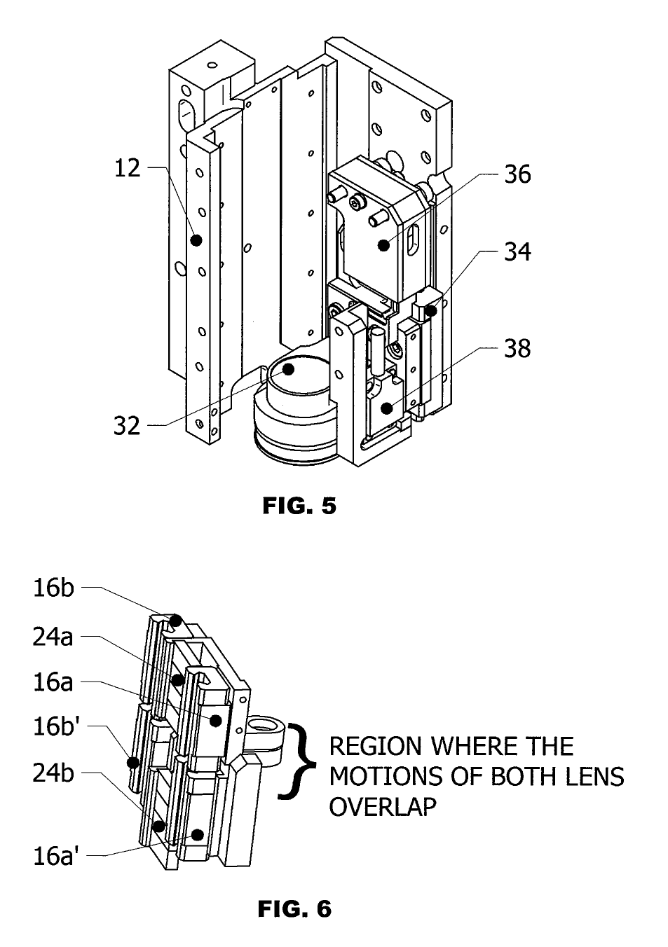

FIG. 5 is an isometric view of the optical zoom system 10 that illustrates an optical focusing portion of the system. The focusing lens system comprises a focusing lens 32, a highly rigid focusing lens linear guiding system 34, an electromagnetic focusing lens linear motor 36 and a focusing lens optical encoder 38. The aforesaid components of the focusing system are preferably connected to the base structure 12. Due to limited space, the focusing lens system is preferably connected to a second, perpendicular vertical sidewall of the base support 12. However, in general, the focusing lens system could also be connected to the first vertical sidewall of the base support 12.

It should be noted that the lens system may also be constructed as a group of lenses, each comprising a plurality of lenses fixed together. Accordingly, the invention is applicable to a pair of lenses, or a pair of lens groups, independently movable in relation to one another via direct drive linear motors. The two lens groups may also be constructed as aforesaid and share the same bearing structure, in order to improve the accuracy of the zooming mechanism.

When the correct currents are applied to the coils of the zoom linear motors 20a, 20b, the zoom lenses 18a, 18b will move along the direction of the linear guides 14a, 14b. The zoom lenses 18a, 18b can be operated successively or simultaneously. For some ranges of optical magnification, it may be necessary for the zoom lenses 18a, 18b to occupy the same position in the direction of motion, although not at the same time.

FIG. 6 is an isometric view of the guide rails showing a region where the motions of the optical zoom system's zoom lenses 18a, 18b may overlap. Thus, both the zoom lenses 18a, 18b are movable to occupy positions within the positional overlap region. The positional overlap region is preferably located at a central region of the two zoom motion systems.

During operation, the positional relationships between the zoom lenses 18a, 18b as well as the focusing lens 32 for each magnification level are predetermined, and the optical zoom mechanism can operate at high speed and accuracy by using the linear motors 20a, 20b, 36 and positional information from the encoders 28a, 28b, 38 to position the respective lenses 18a, 18b, 32 at the required positions for inspection performed at each magnification level.

It should be appreciated that the optical zoom system according to the preferred embodiment of the invention thus allows for fast dynamic response while ensuring high placement accuracy.

The invention described herein is susceptible to variations, modifications and/or additions other than those specifically described and it is to be understood that the invention includes all such variations, modifications and/or additions which fall within the spirit and scope of the above description.

1. An optical zoom mechanism comprising:
a first zoom lens movable along a linear axis that is connected to a support structure;
a second zoom lens movable along the same linear axis as the first zoom lens that is connected to the support structure;
first and second direct drive linear motors coupled to the first and second zoom lenses respectively that are operative to independently move the zoom lenses along the linear axis; and
first and second encoders coupled to the first and second direct drive linear motors respectively that are operative to independently measure the positions of the first and second zoom lenses respectively.

2. The optical zoom mechanism as claimed in claim 1, including at least two linear guides for guiding movement of each zoom lens along the linear axis.

3. The optical zoom mechanism as claimed in claim 2, wherein the at least two linear guides are spaced apart and are parallel to each other.

4. The optical zoom mechanism as claimed in claim 2, further comprising two or more separate guide blocks connected to each zoom lens which are slidably attached to the linear guides.

5. The optical zoom mechanism as claimed in claim 4, wherein each linear guide comprises one single guide rail for guiding the first and second zoom lenses but separate guide blocks connected to each zoom lens for guiding each zoom lens.

6. The optical zoom mechanism as claimed in claim 2, wherein the linear guides comprise a positional overlap region configured such that both the first and second zoom lenses are movable to occupy positions within the positional overlap region.

7. The optical zoom mechanism as claimed in claim 1, wherein the said first and second direct drive linear motors are electromagnetic linear motors each comprising a relatively stationary coil assembly and a movable magnet assembly that is movable with respect to the coil assembly.

8. The optical zoom mechanism as claimed in claim 1, wherein the said first and second direct drive linear motors are electromagnetic linear motors each comprising a relatively stationary magnet assembly and a movable coil assembly that is movable with respect to the magnet assembly.

9. The optical zoom mechanism as claimed in claim 1, further comprising a focusing lens that is actuated using a direct drive linear motor.

10. The optical zoom mechanism as claimed in claim 9, wherein the focusing lens is connected to the same support structure as the first and second zoom lenses.

11. The optical zoom mechanism claimed in claim 1, including an air bearing for guiding movement of either or both of the zoom lenses along the linear axis.

12. The optical zoom mechanism claimed in claim 1, including flexure bearings for guiding movement of either or both of the zoom lenses along the linear axis.

13. The optical zoom mechanism as claimed in claim 1, wherein the encoders comprise optical-type encoders.

14. The optical zoom mechanism as claimed in claim 13, wherein the optical-type encoder comprises a single stationary optical scale that is referable by separate movable optical readheads coupled to the first and second direct drive linear motors respectively.

15. The optical zoom mechanism as claimed in claim 1, wherein the encoders comprise magnetic-type encoders.

16. The optical zoom mechanism as claimed in claim 1, wherein the encoders comprise capacitive-type encoders.
